(19) United States
(12) Patent Application Publication
(10) Pub. No.: US 2023/0092587 A1
(43) Pub. Date: Mar. 23, 2023

(54) THERMOCHROMIC SECURITY ELEMENT AND METHOD FOR PRODUCING A THERMOCHROMIC SECURITY ELEMENT

(71) Applicant: LEONHARD KURZ Stifting & Co. KG, Fürth (DE)

(72) Inventors: Violetta Olszowka, Zirndorf (DE); Martina Schmidt, Stein (DE)

(21) Appl. No.: 17/948,413

(22) Filed: Sep. 20, 2022

(30) Foreign Application Priority Data
Sep. 21, 2021 (DE) 10 2021 124 407.2

(51) Int. Cl. B42D 25/373; B41M 3/14; B41M 5/28; B42D 25/29; B42D 25/45

(52) U.S. Cl. CPC B42D 25/373; B41M 3/142; B41M 5/282; B42D 25/29; B42D 25/45; B41M 2205/40

(57) ABSTRACT

A security element (1) as well as a method for producing a security element (1). The security element (1), in particular a security strip or a security thread or a patch or a transfer film (2) or a laminating film or a print, for protecting security documents (3), includes at least one thermochromic element (11), wherein
i) the at least one thermochromic element (11) has haptic properties; and/or
ii) the security element (1) has at least one haptic layer (12).

### BACKGROUND OF THE INVENTION

The invention relates to a security element and a method for producing a security element.

Thermochromic components change their color in the case of a change in temperature. The color change temperature at which the thermochromic component changes its color depends on the respective raw material chosen. The change in color results from an alteration of the crystalline or molecular structure of the thermochromic component. Such thermochromic components are already used in packaging, household items (such as e.g. cups), jewelry (e.g. mood rings) and security coatings.

A method for printing a thermochromic varnish on a security document is already known from U.S. Pat. No. 5,826,915 A. To check authenticity, the observer has to expose the thermochromic material to heat. This can be effected in the form of friction and/or touch and/or other heat sources. As a result, the color of the thermochromic material changes and the authenticity of the security document can be verified.

### SUMMARY OF THE INVENTION

The object of the invention is now to provide an improved security element with thermochromic elements and haptic properties, as well as an improved method for producing such a security element.

The object is achieved by a security element, in particular a security strip or a security thread or a patch or a transfer film or a laminating film or a print, for protecting security documents, wherein the security element has at least one thermochromic element, wherein

i) the at least one thermochromic element has haptic properties; and/or

ii) the security element has at least one haptic layer.

In particular, it is provided that the at least one thermochromic element is designed such that it has a haptic surface.

This object is further achieved by a method for producing a security element, in particular according to claims 1 to 39, wherein the following steps are carried out, in particular in the following order:

providing at least one thermochromic element and/or applying at least one thermochromic element to a target substrate or a carrier layer, wherein

i) the at least one thermochromic element has haptic properties; and/or

ii) at least one haptic layer is applied.

It has been shown here that through the security element according to the invention and the method according to the invention for producing a security element an improved security element is obtained which has both thermochromic and haptic properties and combines these to form a unique security element. Because the security element has both haptic and thermochromic properties, the observer or user is required to touch the security element in order to check the authenticity. Because the thermochromic element itself has haptic properties or because a haptic layer is arranged under the thermochromic element, the observer or user can perceive a certain tactility when touching the security element, in particular with one or more fingers of their hand. At the same time, checking the tactility by touch also brings about a heat input, in particular through the observer's or user's body heat, into the thermochromic element, which thereby generates a color change. The predefined color change is a further feature for checking the authenticity of the security element. The visually perceptible change in color due to touch and the associated heat input is thus a rapid check of the authenticity of the security element which is to be accomplished without further aids. Through the combination of the haptic properties with the thermochromic properties of the security element, a double authenticity check thus inevitably takes place due to the touch on the security element, for which the observer or user only needs to carry out one checking step, namely touching the security element.

In addition, for example, the tactility of this security element can help visually impaired people to recognize the denomination or the authenticity of banknotes or security documents.

Further advantageous designs of the invention are described in the dependent claims.

In particular, it is provided that the security element comprises a carrier layer and/or at least one primer and/or at least one protective varnish layer.

It can also be provided that the at least one primer is arranged on the side of the carrier layer opposite the at least one thermochromic element.

It is also possible for the at least one primer to comprise an adhesive or combinations of adhesives selected from: monolayer adhesive, multilayer adhesive, water-based adhesive, solvent-based adhesive, solvent-free adhesive, radiation-curing adhesive, thermally activatable adhesive, thermally curable adhesive. The combination of these adhesives can be effected as a mixture of such components and/or as a combination of several layers arranged one over another and/or several regions of surface arranged one next to another, which in each case have adhesives with different and/or similar properties.

It is preferably provided that the adhesive or the adhesives of the at least one primer is applied by means of a printing method and/or by means of pouring and/or by means of a doctor blade. Further, it is advantageous if the adhesive or the adhesives of the at least one primer is applied at least partially, preferably over the whole surface. In particular, it is possible for the layer thickness of the individual adhesives of the at least one primer to have a layer thickness in the range of from 0.01 μm to 12 μm, preferably from 0.05 μm to 8 μm.

In particular, it is provided that the adhesive or the adhesives of the at least one primer has at least one binder or combinations of binders selected from: polyacrylates, polyurethanes, epoxides, polyesters, polyvinyl chlorides, rubber polymers, ethylene-acrylic acid copolymers, ethylene-vinyl acetates, polyvinyl acetates, styrene block copolymers, phenol formaldehyde resin glues, melamines, alkenes, allyl ethers, vinyl acetate, alkyl vinyl ethers, conjugated dienes, styrene, acrylates.

It is further preferably provided that the varnish from which the adhesive of the at least one primer is produced by an application method has a solvent or combinations of solvents selected from: water, aliphatic (benzine) hydrocarbons, cycloaliphatic hydrocarbons, terpene hydrocarbons, aromatic (benzene) hydrocarbons, chlorinated hydrocarbons, esters, ketones, alcohols, glycols, glycol ethers, glycol ether acetates. This solvent or solvent mixture is in large part removed again in the application process, in particular by drying or evaporation.

It is further also possible for the adhesive or the adhesives of the at least one primer to have an additive or combination of additives selected from: curing agents, crosslinkers, photoinitiators, fillers, stabilizers, inhibitors, corrosion inhibitors, additives, in particular flow additives, defoamers, deaerators, dispersing additives, wetting agents, lubricants, matting agents, rheological additives, pigments, anti-corrosive pigments, dyes, waxes. Through the suitable choice of fillers or waxes, for example the tackiness of the at least one primer, in particular at room temperature, can be reduced.

In particular, a thermally activatable adhesive and/or an adhesive which has thermoplastic and/or UV-based raw materials has a solids content in the range of from 10% to 100%, preferably from 15% to 35%. The coating at the varnishing machine can thereby be effected with good quality. It is preferably also provided that the adhesive has a non-tacky surface after drying, in particular at room temperature. It is also advantageous if the choice of the raw materials of the adhesive is chosen such that the processing temperature during the production of the security element always lies above the glass transition temperature and below the melting point of the adhesive.

A multilayer adhesive offers the advantage in particular that a sufficient adhesion can be achieved even between very challenging surfaces. Moreover, a multilayer structure makes a primer with which various types of chemical and physical stability can be achieved possible. The ability of the adhesive to resist the action of chemicals is called chemical stability. The composition of the adhesives is preferably chosen such that they have a sufficient stability with respect to predefined chemicals. Further, it is advantageously provided that there is an inter-coat adhesion between the individual adhesive layers in the case of multilayer adhesives. This is effected by a suitable choice of the glue components.

In particular, it is possible for the at least one protective varnish layer to be arranged above the at least one thermochromic element. The protective varnish layer is preferably a transparent, in particular colorless, layer which protects the thermochromic element from external environmental influences. Such environmental influences can be physical, chemical or mechanical stresses. The protective varnish layer is preferably applied by means of a printing process and/or by means of pouring and/or by means of a doctor blade.

In particular, the at least protective varnish layer has a thickness in the range of from 0.01 μm to 10 μm, preferably from 0.05 μm to 7 μm, particularly preferably from 0.1 μm to 5 μm.

In particular, it is provided that the method further comprises the following step:
applying at least one primer, in particular wherein the at least one primer is applied to the side of the carrier layer opposite the at least one thermochromic element, and/or applying at least one protective varnish layer, in particular wherein the at least protective varnish layer is applied to the at least one thermochromic element.

It is preferably also possible for the at least one protective varnish layer to be applied over the at least one thermochromic element. By “over the at least one thermochromic element” is meant here that the thermochromic element is provided with a protective varnish layer, which is preferably transparent, on its visible face. In other words, the protective varnish layer preferably represents the outermost layer of the security element, wherein the at least one thermochromic element is arranged directly underneath the at least one protective varnish layer.

It is preferably provided that the carrier layer has a thickness in the range of from 1 μm to 500 μm, preferably from 3 μm to 75 μm, particularly preferably from 6 μm to 50 μm.

It is advantageously provided that the carrier layer is formed monolayer or multilayer and comprises a material or a combination of materials selected from: PET (polyethylene terephthalate), PP (polypropylene), PE (polyethylene), PEN (polyethylene naphthalate), PC (polycarbonate), PVC (polyvinyl chloride), Kapton® (poly-oxydiphenylene-pyromellitimide), polyimides, PLA (polyactate), PMMA (polymethyl methacrylate), ABS (acrylonitrile butadiene styrene) and/or cellulose-based substrates.

In particular, it is provided that the method further comprises the following step, which is in particular carried out before the step of applying at least one thermochromic element to a carrier layer:
providing a carrier layer.

It is preferably also possible for the carrier layer to have at least one adhesion-promotor layer, in particular wherein the adhesion-promoter layer has a thickness in a range of from 1 nm to 5 μm, preferably from 5 nm to 3 μm. This adhesion-promoter layer is often applied during the carrier production process. However, it is also possible to apply this adhesion-promoter layer at a later point in time.

An adhesion-promoter layer, or also called primer, increases the adhesion between two layers which would otherwise not have sufficient adhesion to each other. For example, this can be the adhesion of the carrier layer to the thermochromic element or to a replication varnish layer. The adhesion-promoter layer preferably comprises a material or combinations of materials selected from: polyester, epoxide, polyurethane, acrylate, copolymer resins.

The adhesion-promoter layer can be designed to be thermoplastic or UV-curable or as a hybrid variant (thermoplastic and UV-curable) or as a cold glue/primer or self-adhesive primer, with a layer thickness of from 0.01 μm to 15 μm, preferably from 0.1 μm to 5 μm. Inorganic materials, such as metals, metal oxides, alloys, oxides or silicates, can also act as adhesion promoters or be a constituent of such a system.

The increase in the adhesion between carrier layer and thermochromic element or replication varnish layer can optionally also be achieved by surface-activating processes such as corona or plasma treatment. These can also be used in combination with an adhesion promoter.

If the security element is used as a transfer film, in particular as a stamping film, it can also make sense to introduce the thermochromic element into the adhesion-promoter layer. If the thermochromic element also has haptic properties, then the haptic properties can be brought about by the locally different application weight of the adhesion-promoter layer. In addition to or instead of a different level of application weight of the adhesion-promoter layer in the decoration, the haptic properties can result from additives or thermochromic elements themselves.

It is advantageously possible for the provision of the at least one thermochromic element and/or application of the at least one thermochromic element to be carried out by means of screen printing and/or reverse printing and/or gravure printing.

In particular, it is provided that the security element has a transfer ply detachable from the carrier layer, in particular wherein the transfer ply comprises the at least one thermochromic element and/or the at least one haptic layer and/or at least one primer and/or at least one protective varnish layer.

It is further also possible for the method further to comprise the following step, which is in particular carried out after the step of providing a carrier layer:
applying a transfer ply detachable from the carrier layer, in particular wherein the transfer ply comprises the at least one thermochromic element and/or the at least one haptic layer and/or at least one primer and/or at least one protective varnish layer.

Further, it is possible for the method further to comprise the following step, which is in particular carried out before the step of applying the transfer ply:
applying a detachment layer to the carrier layer by means of printing processes, in particular wherein the detachment layer is arranged between the carrier layer and the transfer ply.

It is preferably possible for the at least one primer to be arranged such that it is arranged under the at least one thermochromic element after application of the transfer ply to a target substrate. It is thereby ensured that the at least one thermochromic element can be visually perceived by the observer in the case of perpendicular observation onto the security element or security document.

It is also possible for the at least one protective varnish layer to be arranged such that it is arranged over the at least one thermochromic element after application of the transfer ply to a target substrate. The protective varnish layer does not impair the visual perceptibility of the at least one thermochromic element, as the protective varnish layer is preferably designed to be transparent, in particular colorless. The protective varnish layer serves to protect the at least one thermochromic element from external environmental influences.

Further, it is possible in particular for the at least one primer to be applied by means of printing processes and/or a doctor blade and/or pouring such that it is arranged under the at least one thermochromic element after the application of the transfer ply to a target substrate.

It is advantageously provided that the at least one primer is applied at least partially, preferably over the whole surface, with a layer thickness in the range of from 0.01 μm to 12 μm, in particular from 0.05 μm to 8 μm.

Furthermore, it is preferably possible for the security element to comprise a detachment layer, which is in particular arranged between the carrier layer and the transfer ply.

It is preferably provided that the detachment layer comprises at least one material or a combination of materials selected from: wax, carnauba wax, montanic acid ester, polyethylene wax, polyamide wax, PTFE wax, silicone, melamine formaldehyde resin.

In an advantageous embodiment, it can be provided that the detachment layer has a layer thickness smaller than 1 μm, in particular smaller than 0.5 μm.

The detachment layer is preferably a polymeric detachment layer which has a better and/or a different detachment behavior than conventional carrier layers. Such detachment layers are irreversibly joined to the carrier layer and a transfer ply is arranged on the detachment layer. The transfer ply can in particular be more easily detached from the carrier layer with a polymeric detachment layer, with the result that a cleaner decoration of the transfer ply on the target substrate can be effected.

It can also be possible for the transfer ply or the security element to have a decorative ply, in particular wherein the decorative ply has at least one color layer and/or at least one replication varnish layer and/or at least one metal layer and/or at least one lens layer. The decorative ply can thus be one or more layers of the transfer ply or one or more layers which are printed directly onto a carrier layer or a target substrate, in particular security document.

By a replication varnish layer is preferably meant here a specific functional layer into which optically variable structures are introduced and/or fixed, in particular by means of thermal replication and/or UV replication. In the case of a hybrid replication varnish layer, the latter is for example first thermally replicated and then cured by means of radiation, for example by means of UV radiation and/or at least one electron beam. In the case of a UV-based replication varnish layer, the latter is replicated at room temperature and then cured by means of radiation, for example by means of UV radiation and/or at least one electron beam. For example, it is possible for the replication varnish additionally to become warm during a UV replication, in particular due to heat input during the UV irradiation.

It is preferably provided that the replication varnish layer has a thickness in the range of from 0.1 μm to 70 μm, preferably from 0.3 μm to 50 μm.

However, it is also possible for the replication varnish layer to have a haptic property, in particular in the form of three-dimensional structures with heights and depths. In particular, these are three-dimensional structures which can be sensed or felt by the observer when touched. Preferably, it is then provided that the thermochromic element is arranged over the replication varnish layer such that it adapts to the three-dimensional structures of the at least one replication varnish layer. In particular, it is provided that the at least one haptic layer comprises at least one replication varnish layer.

In particular, it is possible for the at least one replication varnish layer to have optically variable structures, selected individually or in combination from: diffractive structures, refractive structures, isotropic matte structures, anisotropic matte structures, which are preferably introduced by means of thermal replication and/or UV replication. In particular if the replication varnish layer is deposited over the whole surface, the replication varnish layer is visible for the observer in the regions in which the color layer and/or the metal layer and/or the at least one thermochromic element are not provided. A particularly striking optical effect results for the observer from the optically variable structure of the replication varnish layer. At the same time, this also increases the security with respect to forgeries.

In particular, it is provided that the at least one replication varnish layer is arranged registration- or register-accurate relative to the at least one color layer and/or the at least one metal layer and/or the at least one thermochromic element.

By registered or register or registration-accurate or register-accurate or registration accuracy or register accuracy is meant a positional accuracy of two or more layers relative to each other. The register accuracy is to vary within a predefined tolerance, which is to be as small as possible. At the same time, the register accuracy of several elements and/or layers relative to each other is an important feature for increasing the process reliability. The positionally accurate positioning can in particular be effected by means of sensorially, preferably optically detectable registration marks or register marks. These registration marks or register marks can either represent specific separate elements or regions or layers or themselves be part of the elements or regions or layers to be positioned.

In particular, it is provided that the at least one metal layer comprises a material or a material combination selected from: aluminum, silver, chromium, copper, tin, gold, zinc or an alloy of the above-named metals. Further, it is also possible for the at least one metal layer to comprise a material selected from: blackened aluminum, in particular substoichiometric AlₓO_{y}, or oxidized silver. The metal layer can be designed merely partially metallized or also fully metallized.

In particular, it is possible for the at least one metal layer to be arranged register-accurate or registration-accurate, in particular exactly registered, relative to the at least one color layer and/or to the at least one thermochromic element.

Furthermore, it is possible for the at least one metal layer to be provided in a first region and not to be provided in a second region. It is advantageously provided that the at least one metal layer is applied in a first region and is not applied in a second region. Further, it is also possible for the at least one metal layer to be applied over the whole surface. In this case, it is provided in particular that the metal layer applied over the whole surface is structured or demetallized, in particular by means of etching and/or by means of washing processes.

It is furthermore possible for the at least one metal layer to be applied by means of vapor deposition and/or sputtering.

The at least one metal layer is advantageously designed to be transparent or partially transparent or opaque or translucent.

The at least one metal layer can act as a metallic mirror layer or as a semi-transparent absorber layer. The layer thickness of such a metal layer is preferably between 1 nm and 500 nm, further preferably between 5 nm and 100 nm. This layer can typically serve as a metallic mirror layer from a layer thickness of approx. 15 nm. In the case of a layer thickness of less than 15 nm, this layer can act as a semi-transparent absorber layer. It is also possible for such a layer to be formed by application of metal-pigment-containing varnishes, wherein the layer thickness lies in particular between 0.1 μm and 50 μm, preferably from 1 μm to 20 μm.

Further, a so-called thin film layer system can also be provided, which comprises a first metal layer and a second metal layer, as well as a spacer layer arranged between these two metal layers. The first metal layer is preferably formed opaque, and forms a so-called metallic mirror layer. The second metal layer is preferably formed transparent or partially transparent, and forms a so-called absorber layer. The two metal layers can in each case also be formed as HRI layers. The spacer layer is preferably printed, and consists of a low-refractive-index varnish.

The at least one color layer preferably consists of a binder, an additive, and/or fillers. By color layer is preferably meant a specific functional layer which generates in particular a color impression detectable for an observer and/or further preferably is used as a mask layer, in particular as an exposure mask, and/or as an etch resist.

By color is meant in particular a dyeing which, with respect to the transparency and/or the clarity or the scattering power, preferably comprises dyed crystal clear transparent or dyed scattering transparent or also dyed opaque. The color preferably occurs as the intrinsic color of a material and/or is arranged as an additional dyed layer in front of a layer as in the viewing direction, wherein the layer lying underneath, in particular the metal layer, is modified in terms of its colored appearance, in particular for an observer. The color here preferably appears optically constant or invariable in terms of its hue and/or its color saturation and/or in terms of its transparency from almost all, in particular from all, observation and/or illumination angles. Further, it is possible for the color itself to be optically variable, wherein the hue and/or the color saturation and/or the transparency of the color changes in particular as the observation and/or illumination angle changes.

The at least one color layer is preferably formed as a glazed color layer, in particular as a color layer showing through transparently or translucently. Further preferably, the at least one color layer preferably comprises an additive which preferably absorbs light in the ultraviolet wavelength range, in particular in a wavelength range of between 200 nm and 380 nm. Such UV blockers preferably strengthen the function of the color layer as a mask layer. In particular, the UV blockers have no or only a very small absorption in the wavelength range visible to the human eye of from 380 nm to 780 nm, in order in particular not to alter the color impression of the at least one color layer.

By binders is preferably meant polymer-based systems and mixtures thereof, such as for example polyester, polyacrylate, polymethacrylate, polyurethane, polystyrene, polybutyrate, nitrocellulose, polyvinyl chloride, ethylene vinyl acetate, their copolymers or similar polymers.

By additives is preferably meant organic or inorganic substances which achieve the processing properties, for example during the application of a color layer or during use of the security element itself, a predetermined effect.

By fillers is preferably meant all further materials added to a system, in particular a polymer-based system, such as for example silica, pigments, dyes, UV blockers (UV=UV radiation=ultraviolet radiation=electromagnetic radiation from the ultraviolet portion of the spectrum of electromagnetic radiation or from one or more partial ranges from the ultraviolet portion of the spectrum of electromagnetic radiation), tracers, in particular taggants, and/or similar materials.

Dyes and/or pigments are preferably suitable as coloring substances of the at least one color layer. These coloring substances are called colorants in the following. Pigments are preferably practically insoluble, in particular insoluble, in the medium in which they are integrated. Dyes preferably dissolve during their usage and in particular lose their crystalline and/or particulate structure. Possible classes of dyes are basic dyes, liposoluble dyes or metal-complex dyes. Possible classes of pigments are organic and inorganic pigments. Pigments are preferably constructed from a material present in one piece or, alternatively, in particular have complex structures, for example as a layer structure with a plurality of layers of different materials and/or for example as capsules of different materials, in particular with a core and a shell.

The colors of the at least one color layer are in particular transparent or at least translucent, wherein the transmittance is preferably between 5% and 99%, in particular over a partial range of the wavelength range visible to the human eye of from 380 nm to 780 nm, preferably in the range of from 430 nm to 690 nm. In particular, optically variable effects of the optically variable structures which are arranged underneath the at least one color layer from the viewing direction of the observer and are introduced in particular into the at least one replication varnish layer are detectable.

Further, it is possible for the at least one color layer to be formed and/or consist of several different colors, wherein these preferably also have regions with color mixing of the first and second colors, which form by means of overlapping the color layers and/or by halftoning the color layers. In particular, the color saturation in the color layers varies.

The color layer can be generated with at least one pigment or a colorant with the color cyan, magenta, yellow or black (CMYK =Cyan Magenta Yellow Key: black as color depth) or the color red, green or blue (RGB), in particular for generating a subtractive mixed color.

As an alternative to the mixed color, pigments or dyes which generate a specific, in particular pre-mixed, special color or color from a specific color system (e.g. RAL, HKS, Panton®), for example orange or purple, can also be used.

In particular, it is provided that the at least one color layer has a layer thickness in the range of from 0.1 μm to 30 μm, preferably in the range of from 0.1 μm to 5 μm.

Further, it is also preferably possible for the at least one color layer to be applied with a layer thickness in the range of from 0.1 μm to 30 μm, preferably in the range of from 0.1 μm to 5 μm.

The color can be generated directly by thermochromic components. The thermochromic substance can additionally be added to the coloring pigments or dyes of the varnish, and thus form a mixed color. In particular, it is then provided that the at least one color layer is designed as the at least one thermochromic element.

In particular, it is possible for the at least one color layer to be arranged in the decoration, preferably to be arranged register-accurate or registration-accurate relative to the at least one replication varnish layer and/or the at least one metal layer and/or the at least one thermochromic element. It is preferably also provided that the at least one color layer is applied in the decoration, in particular is applied registration-accurate or register-accurate relative to the at least one replication varnish layer and/or the at least one metal layer and/or the at least one thermochromic element.

It is possible for the layers of the security element, in particular of the decorative ply, to have organic UV absorbers, in particular benzotriazole derivatives, with a mass fraction in a range of from approx. 3% to 5%, in particular if the material of the layers does not contain a sufficient quantity of UV-absorbing constituents, such as for example UV-absorbing pigments or UV-absorbing dyes. Suitable organic UV absorbers are sold by BASF under the trade name Tinuvin®.

The transparent varnish layer with the UV blocker is chosen such that it can be washed away with the same developer solution or the same solvent as the photoresist layer. Finely structured regions, which preferably have the UV blocker layer and a dyed photoresist, and regions without these two layers, hereby form on the carrier layer.

For the structuring of the at least one metal layer, a positive photoresist is preferably used, the solubility of which in particular increases when activated by exposure to light.

In particular, a positive photoresist is characterized in that, when sufficiently exposed to light with a suitable wavelength, such as for example by means of UV radiation, this photoresist becomes soluble in a particular solvent, for example in acidic or basic aqueous solutions, in the exposed regions.

A positive photoresist preferably comprises for example condensation polymers of m- and p-cresol and formaldehyde (Novolak resin), diazonaphthoquinone derivative (DNQ) and solvent or solvent mixture, such as for example 1-methoxy-2-propyl acetate.

In particular, it is provided that the following step is further performed in the method:

applying at least one photoresist layer over the whole surface, in particular with the result that the photoresist layer is applied underneath the at least one metal layer and/or the at least one thermochromic element.

Further, it is also preferably provided that the following step is further performed in the method after the step of applying the at least one photoresist layer:

exposing the at least one photoresist layer of the security element to light, in particular with the result that the at least one color layer and/or the at least one thermochromic element serves as an exposure mask for the at least one photoresist layer, and the at least one photoresist layer is activated, wherein:

the at least one photoresist layer becomes soluble in a particular solvent, in particular acidic or basic solutions, in the second regions, or

the at least one photoresist layer becomes insoluble in a particular solvent, in particular acidic or basic aqueous solutions, in the first regions.

By second region is meant the region which is not to be covered with a metal layer. On the other hand, the metal layer is preferably present in the first region.

It is advantageously possible for the following step further to be performed in the method after the step of exposing the at least one photoresist layer to light:

structuring the at least one photoresist layer by means of a solvent, in particular an acidic or basic solution, with the result that the at least one photoresist layer is removed in the second regions and is preserved in the first regions.

In particular, it is provided that the following step is further performed in the method after the step of structuring the at least one photoresist layer:

demetallizing the at least one metal layer by means of etching, wherein the at least one photoresist layer serves as an etch resist and the at least one metal layer is removed in the second regions and is preserved in the first regions, in particular with the result that the metal layer is demetallized exactly registered relative to the at least one color layer and/or the at least one thermochromic element.

It is then advantageously provided that the at least one photoresist layer is removed, with the result that it is no longer present in the structure of the security element.

The register between the at least one thermochromic element and the at least one metal layer can preferably be achieved by means of a so-called photoresist, called negative photoresist in the following, which is in particular dyed. This photoresist can be dyed with a thermochromic component and/or a thermochromic component with an additional color varnish. A negative photoresist is characterized in that this varnish cures when sufficiently exposed to light with a suitable wavelength, e.g. with UV light, and thereby becomes insoluble in a particular solvent, e.g. in acidic or basic aqueous solution, in the exposed regions. Through a masked exposure to light, dyed regions with a defined shape and size can therefore be achieved, wherein in the example described an exact register, thus virtual congruence, between the negative photoresist and the metal layer is achieved.

The main constituents of a negative photoresist based on epoxy resin are generally low-molecular-weight organic compounds, which have more than one epoxide group per molecule. Epoxy resins based on bisphenol A, epoxidized phenolic novolac, resorcinol glycidyl ether as well as cycloaliphatically structured resins are often used as resin component for producing negative photoresists.

In conjunction with a crosslinker (curing agent), the so-called resin/curing agent system provides a macromolecular network by polymerization of the epoxide group. In practice, a large number of different curing agents which are distinguished by the ring-opening reaction of the oxirane groups is used. Acid anhydrides, amines or phenol-containing compounds are often used, or triarylsulfonium salts are often used as photoactive component.

Furthermore, catalysts, such as e.g. Lewis bases and acids, are used. The curing agent is incorporated in the three-dimensional network structure. The catalyst promotes the network formation via ester bridges in the case of a basic accelerator.

For example g-butyrolactone is used as standard solvent for epoxy-resin-based negative photoresists. Thus, for example, SU-8 (epoxy novolac based on bisphenol A) is also used for the negative resist.

Additives such as for example long-chain epoxy resins preferably act as adhesion promoters, reactive thinners or as an augmentation or lowering of the viscosity.

In particular, it is provided that the at least one thermochromic element is arranged over the whole surface or at least in regions, in particular partially or in the decoration. It is preferably also possible for the at least one thermochromic element to be applied over the whole surface or at least in regions, in particular partially or in the decoration. For example, security strips, which are transferred to a target substrate by means of a transfer method, are appropriate as thermochromic elements over the whole surface. In this case, the entire strip is designed as a thermochromic element and changes its color when heat is input and at the same time the color change point is exceeded. In the case of a thermochromic element as decoration, it is appropriate for example for this to have an element selected from: graphically designed outline, a figural representation, an image, an individual image, a pattern, an endless pattern, a motif, a symbol, a logo, a portrait, a grid, an alphanumeric character, a text and/or combinations thereof. In the case of a thermochromic element as decoration, it is in addition preferably possible for this to be designed by means of a dot grid, line grid and/or a predefined repeating patterning.

Further, it is also possible for the at least one metal layer to be arranged under the at least one thermochromic element, in particular wherein the at least one metal layer is arranged register-accurate and/or registration-accurate, preferably exactly registered, relative to the at least one thermochromic element. Further, it is provided that the at least one thermochromic element is applied over the at least one metal layer, in particular wherein the at least one thermochromic element is arranged register-accurate and/or registration-accurate, preferably exactly registered, relative to the at least one metal layer.

Through the registration-accurate arrangement, it is possible for example for the thermochromic element to conceal the optical information of the metal layer lying underneath it in the non-activated state. If the thermochromic element is activated, however, in particular by heat input and simultaneous exceeding of the color change temperature, then the optical information of the metal layer becomes visible for the observer. For example, it is possible for both the metal layer and the thermochromic element to be formed as stars, which are arranged registration-accurately one over the other. For example, the star of the metal layer is designed in a first color and the star of the thermochromic element is designed in a second color. When the thermochromic element is activated, it changes its color from the second color to colorless. The star in the first color of the metal layer thereby becomes visible for the observer.

It is preferably also possible for the at least one thermochromic element to be designed as an etch resist, in particular as a negative or positive photoresist, for the structuring of the at least one metal layer and/or as an exposure mask for the structuring of an etch resist. A registration-accurate arrangement and/or register-accurate arrangement and/or an exact registering of the at least one thermochromic element relative to the at least one metal layer can thereby be made possible.

In particular, it is provided that the at least one thermochromic element has a color change point in a temperature range of from −20° C. to 120° C., preferably from 0° C. to 60° C., particularly preferably from 15° C. to 45° C., with the result that when this color change point is exceeded the appearance of the at least one thermochromic element changes from a first color to a second, in particular transparent, color and/or when this color change point is fallen below the appearance of the at least one thermochromic element changes from the second, in particular transparent, color to a first color. It is thus possible for example for the thermochromic element to change its color and for it to be always visible for the observer. In the case that the thermochromic element changes its appearance to a second transparent or colorless color, items of optical information which are arranged underneath the thermochromic element can become visible for the observer. In addition, this makes a simple check of the security element for its authenticity possible, as no further aid is needed for the color change of the thermochromic element. It is preferably provided that the user who is carrying out the check of the authenticity is acquainted with the color change of the thermochromic element. The authenticity can thereby be rapidly and easily checked. In addition, it is ensured through the above-specified temperature range of the color change point that the color change can be achieved with body heat.

It is preferably also possible for the at least one thermochromic element to comprise at least one thermochromic colorant, and/or for the at least one thermochromic element to comprise a first varnish layer with at least one thermochromic colorant and a second varnish layer with at least one colorant, in particular wherein the at least one thermochromic colorant and the at least one colorant have different colors and in combination has a mixed color as first color of the at least one thermochromic element in a temperature range below the color change point and/or in combination has a mixed color, which substantially corresponds to the color of the at least one colorant, as second color of the at least one thermochromic element in a temperature range above the color change point. Thus, it is possible for example for a blue varnish layer to be mixed with red thermochromic colorants, with the result that a first mixed color generates a lilac color impression for the observer. When the thermochromic element is activated, the thermochromic element changes its color from red to colorless. The observer only perceives the blue color impression of the varnish layer. With such a design, various color change effects which can be used to check authenticity can thus be achieved.

In particular, it is possible for the at least one thermochromic element to comprise a first varnish layer with at least one first thermochromic colorant and a second varnish layer with at least one second thermochromic colorant, in particular wherein the at least one first thermochromic colorant and the at least one second thermochromic colorant have different colors and in combination has a mixed color as first color of the at least one thermochromic element in a temperature range below the color change point and/or in combination has a mixed color, which appears substantially colorless, as second color of the at least one thermochromic element in a temperature range above the color change point.

It can also be possible for the first varnish layer and the second varnish layer to have a color difference ΔE in the range of from 50 to 270, preferably from 100 to 270, particularly preferably from 130 to 270.

In particular, it is provided that the total color difference ΔE of all color components L, a and b is specified for a good contrast in the CIELAB space. In the CIELAB system the color space is defined by a sphere with three axes L, a and b. The color difference ΔE is thus a measure of the perceived color difference between two color locations p=(Lₚ, aₚ, bₚ) and v=(Lᵥ, aᵥ, bᵥ) and is dependent on the application weight of the first and/or second varnish layer. Here, in particular, L_{p,v} is the lightness, a_{p,v} is the color value on the red-green axis and b_{p,v} is the color value on the yellow-blue axis of the two color locations. The color deviation ΔEₚᵥ between two color locations is in particular calculated as follows:

ΔEₚᵥ=\sqrt{(Lₚ−Lᵥ)²+(aₚ−aᵥ)²+(bₚ−bᵥ)²},

wherein preferably the color location with the subscript v corresponds to a first varnish layer with or without a thermochromic component and the color location with the subscript p corresponds to a second varnish layer with or without a thermochromic component. In particular for the human eye, a color deviation is perceptible here from ΔE=1.0 at the earliest. It is preferably provided that the first varnish layer has a dark color with a low L value, in particular an L value of less than 50, and/or the second varnish layer has a light color with a high L value, in particular an L value of more than or equal to 50.

It is preferably also possible for the at least one thermochromic element to be reversible, in particular with the result that a color change from the first color to the second color or vice versa is provided as often as desired, or for the at least one thermochromic element to be irreversible, in particular with the result that only a single color change from the first color to the second color or vice versa is provided. In the case of a thermochromic element which is reversible, the advantage arises that, with this, a check of the authenticity can be carried out as often as desired. For this reason, reversible thermochromic elements are advantageously used for banknotes, ID cards and other security documents. In the case of an irreversible thermochromic element, a use in forgery protection for commercial products is advantageous, for example for the one-time check of the authenticity of a perfume or the like. For this purpose, an irreversible thermochromic element can be applied to the bottle, in order thus to distinguish an original perfume from a fake. A cool check, for example, is appropriate as a further field of use for irreversible thermochromic elements. For this purpose, it is preferably provided that an irreversible thermochromic element is applied to a product to be cooled. If the cool temperature of the product to be cooled is exceeded once, then the thermochromic element changes its appearance. Thus, the appearance of the thermochromic element then indicates whether or not the temperature to be complied with in the cold chain has been exceeded. In the case of perishable goods, which are preferably intended for the food trade, the goods can thus be disposed of, before they come onto the market, if the allowable temperature has been exceeded.

It is preferably also possible for the at least one thermochromic element to have a color change duration of less than 5 seconds, in particular of less than 1 second, in particular wherein the color change duration indicates the time which is required for the color change from the first color to the second color or vice versa. Through such a length of time, it is guaranteed that the check of security elements or security documents for their authenticity can be carried out quickly. This is advantageous in particular in the case of banknotes.

In particular, it is provided that the at least one thermochromic element is oriented towards a visible face, which is visible for the observer, and wherein layers arranged underneath the at least one thermochromic element provide at least one item of information which is at least partially or completely concealed from an observer in the case of a temperature range below the color change point from the first color of the at least one thermochromic element and is visible for the observer in the case of a temperature range above the color change point because of the second, in particular transparent, color of the at least one thermochromic element. The layers arranged underneath the at least one thermochromic element can be for example the decorative plies, such as for example color layers, metal layers and/or replication varnish layers, which provide an item of optical information. The item of optical information can be for example alphanumeric characters, patterns, symbols or motifs. Further, it is expedient if the decorative ply has further optically variable layers, for example with elements and/or substances, individually or in combination, selected from: optically variable pigments, holograms, blazed gratings, relief structures, Kinegram®, optical diffraction structures, lenses, prisms, thin film layers, liquid crystals. Thus, it is advantageous if the decorative ply has at least one layer with a decorative effect.

It is also possible for the proportion of a thermochromic component in the at least one thermochromic element to lie in the range of from 20% to 80%, in particular from 30% to 70%. Through such a proportion, the desired color, the effect, the runnability and/or the possibility of incorporation into varnishes can be adapted individually.

It is preferably possible for the at least one thermochromic element to comprise solids, in particular pigments and/or binders, and solvents.

It is provided in particular that the at least one thermochromic element has a solids content in the range of from 20 wt.-% to 80 wt.-%, preferably from 30 wt.-% to 70 wt.- %, (wt.-% =percent by weight), in particular wherein in the case of the solids content the binder content has in a range of from 20 wt.-% to 80 wt.-%, preferably from 30 wt.-% to 70 wt.-%, and the colorant content 0.5 wt.-% to 80 wt.-%, preferably from 1 wt.-% to 70 wt.-%.

It is preferably possible for the at least one thermochromic element to comprise inorganic thermochromic compounds selected from: rutile, zinc oxide, mercury(II) iodide; and/or organic thermochromic compounds selected from: 9,9′-bixanthylidene, 10,10′-bianthronylidene. For example, thermochromic pigments, encapsulated pigments, dyes and pastes can be introduced through the addition of existing varnish formulations which already fulfil other functions, such as primers, replication varnishes, color varnishes, protective varnishes, etc. The varnishes can be aqueous, solvent-containing, UV-based or also hybrid variants here.

It is preferably possible for the at least one thermochromic element to have a thickness in the range of from 1.0 μm to 1.8 82 m and, in the wavelength range of from 300 nm to 800 nm, in particular from 300 nm to 500 nm, at a temperature in the range of from 20° C. to 25° C., to have a transmittance of at most 70%, preferably at most 65%, particularly preferably at most 60%.

It is also possible for the at least one thermochromic element to have a thickness in the range of from 1.6 μm to 2.4 μm and, in the wavelength range of from 300 nm to 800 nm, in particular from 300 nm to 500 nm, at a temperature in the range of from 20° C. to 25° C., to have a transmittance of at most 50%, preferably at most 45%, particularly preferably at most 40%.

It can preferably also be provided that the at least one thermochromic element has a thickness in the range of from 2.7 μm to 3.3 μm and, in the wavelength range of from 300 nm to 800 nm, in particular from 300 nm to 500 nm, at a temperature in the range of from 20° C. to 25° C., has a transmittance of at most 40%, preferably at most 35%, particularly preferably at most 30%.

Furthermore, it is possible for the at least one thermochromic element to have a thickness in the range of from 3.6 μm to 4.4 μm and, in the wavelength range of from 300 nm to 800 nm, in particular from 300 nm to 500 nm, at a temperature in the range of from 20° C. to 25° C., to have a transmittance of at most 30%, preferably at most 25%, particularly preferably at most 20%.

It is preferably possible for the at least one thermochromic element to have a thermal conductivity in the range of from 0.001 W/m*K to 8000 W/m*K, in particular from 0.005 W/m*K to 6000 W/m*K. It is thereby ensured that the heat input and the resultant change in temperature of the at least one thermochromic element is effected quickly, with the result that the check of the authenticity can be carried out without a long wait.

It is preferably also provided that the heat transferred during the heat transfer by the finger touching the at least one thermochromic element can be calculated by means of Fourier's Law, as follows:

$$Q = \frac{λ \cdot A \cdot Δ T}{d}$$

wherein λ corresponds to the thermal conductivity, A corresponds to the surface area of the touch, ΔT corresponds to the temperature difference and d corresponds to the distance from the medium 1 to the medium 2.

In particular, it is provided that the medium 1 is the thermochromic element and the medium 2 is a human finger. Since the thermochromic element is preferably covered by at least one protective varnish layer, the thickness of the protective varnish layer corresponds to the distance d. In general, it can be said that the higher the thermal conductivity of the thermochromic element is, the more quickly the change in color of the thermochromic element takes place.

It is preferably provided that the at least one haptic layer comprises three-dimensional structures with different height and/or depth, in particular wherein the three-dimensional structures has a height and/or depth in the range of from 0.1 μm to 70 μm, preferably from 0.5 μm to 50 μm, particularly preferably from 0.5 μm to 30 μm. In particular, it is possible for the thickness of the at least one haptic layer on the carrier film to be able to be formed differently, with the result that the three-dimensional structures with different heights and/or depths can be generated at the same time. It is advantageously possible for three-dimensional structures with different height and/or depth to be introduced into the at least one haptic layer, in particular by means of stamps and/or prints and/or rollers, wherein the three-dimensional structures has a height and/or depth in the range of from 0.1 μm to 70 μm, preferably from 0.5 μm to 50 μm, particularly preferably from 0.5 μm to 30 μm.

Further, the haptic layer can also be formed as dots, preferably as braille writing. In particular, the individual dots in each case have a dot diameter in the range of from 0.8 mm to 2.4 mm, preferably from 1.1 mm to 2.1 mm, particularly preferably from 1.5 mm to 1.7 mm

Further, the individual dots can have a particular dot spacing. The dot spacing is defined by the distance from dot center to dot center and in particular lies in a range of from 1 mm to 4 mm, preferably in a range of from 1.5 mm to 3 5 mm, particularly preferably in a range of from 2 mm to 3 mm.

There can also be a particular character spacing between the individual characters. The character spacing is defined by the distance from dot center to dot center and in particular lies in a range of from 2 mm to 9 mm, preferably from 4 mm to 7 mm, particularly preferably from 5 mm to 7 mm.

The distance between the individual lines is called the line spacing and in particular lies in a range of from 5 mm to 15 mm, preferably from 7 mm to 13 mm, particularly preferably from 9 mm to 11 mm.

It is preferably provided that the at least one haptic layer is arranged underneath the at least one thermochromic element, in particular wherein the at least one thermochromic element adapts to the three-dimensional structures of the at least one haptic layer. It is advantageously provided that the at least one haptic layer is applied under the at least one thermochromic element, in particular wherein, through the subsequent application of the at least one thermochromic element, the latter adapts to the three-dimensional structures of the at least one haptic layer.

It is preferably possible for the three-dimensional structures of the at least one haptic layer to be designed as dots, waves, lines and/or combinations thereof and/or as a decorative element.

It is preferably also provided that the at least one haptic layer and/or the at least one thermochromic element comprises replicated structures, in particular lenses, and/or that the at least one haptic layer and/or the at least one thermochromic element has additives, in particular polymethyl methacrylate beads and/or polystyrene beads and/or polymethylsilsesquioxane beads with a diameter in the range of from 0.8 μm to 25 μm. It is preferably also possible for replicated structures, in particular lenses, to be introduced into the at least one haptic layer and/or the at least one thermochromic element and/or for additives, in particular polymethyl methacrylate beads and/or polystyrene beads and/or polymethylsilsesquioxane beads with a diameter in the range of from 0.8 μm to 25 μm, to be introduced into the at least one haptic layer and/or the at least one thermochromic element.

Various haptic effects can be generated through the addition of additives and/or replicated structures.

In particular, it is also possible for the at least one haptic layer to be applied directly to the carrier layer, in particular the adhesion-promoter layer of the carrier layer, and/or for the at least one haptic layer to be a layer of the transfer ply. It is further also possible for the at least one haptic layer to be applied directly to the carrier layer, in particular the adhesion-promoter layer of the carrier layer, and/or wherein the at least one haptic layer is a layer of the transfer ply.

It is further also possible for the at least one thermochromic element to comprise three-dimensional structures with different height and/or depth for generating the haptic properties, in particular wherein the three-dimensional structures has a height and/or depth in the range of from 0.1 μm to 70 μm, preferably from 0.5 μm to 50 μm, particularly preferably from 0.5 μm to 30 μm. It is preferably provided that three-dimensional structures with different height and/or depth for generating the haptic properties are introduced into the at least one thermochromic element, in particular by means of a stamp and/or print and/or roller, wherein the three-dimensional structures has a height and/or depth in the range of from 0.1 μm to 70 μm, preferably from 0.5 μm to 50 μm, particularly preferably from 0.5 μm to 30 μm.

It is preferably provided that the three-dimensional structures of the at least one thermochromic element form through variation of the layer thickness, in particular printed and/or replicated layers and/or through the addition of additives.

It is also possible for the three-dimensional structures of the at least one thermochromic element to be designed as dots, waves, lines and/or combinations thereof and/or as a decorative element.

A use of the security element according to the invention can be effected in the case of security documents, such as for example banknotes, ID cards or the like. Furthermore, such security elements can also be used in forgery protection for commercial products, in particular as protection against fakes, and/or as a cool check of a cold chain. The security element can be a specific security print and/or a security strip applied to a surface of a substrate or a security thread which is embedded in the security document during the production thereof and/or a transfer film which is applied to a security document or to a product or to a product packaging.

### BRIEF DESCRIPTION OF THE DRAWINGS

The invention is explained by way of example in the following with reference to several embodiment examples with the aid of the attached drawings. The embodiment examples shown are therefore not to be understood as limitative.

FIGS. 1a, b in each case show a schematic representation of a layer structure of a security element

FIGS. 2a, b in each case show a schematic representation of a layer structure of a security element

FIG. 3 shows a schematic representation of a security element as a transfer film

FIG. 4 shows a schematic representation of a security element as a transfer film

FIG. 5 shows a schematic representation of a layer structure of a security element

FIG. 6 shows a schematic representation of a security document with an applied security element

FIG. 7 shows a schematic representation of a security document with an applied security element

FIG. 8 shows a schematic representation of a security document with an applied security element

FIG. 9 shows a schematic representation of a security document with an applied security element

FIG. 10 shows a schematic representation of a security document with an applied security element

FIG. 11 shows a schematic representation of a security document with an applied security element

FIG. 12 shows a schematic representation of a security document with an applied security element

FIG. 13 shows a schematic representation of a security document with an applied security element

FIG. 14 shows a graph of the transmittance of a thermochromic element with a layer thickness of from 1.0 μm to 1.8 μm for different wavelengths depending on the color

FIG. 15 shows a graph of the transmittance of a thermochromic element with a layer thickness of from 1.6 μm to 2.4 μm for different wavelengths depending on the color

FIG. 16 shows a graph of the transmittance of a thermochromic element with a layer thickness of from 2.7 μm to 3.3 μm for different wavelengths depending on the color

FIG. 17 shows a graph of the transmittance of a thermochromic element with a layer thickness of from 3.6 μm to 4.4 μm for different wavelengths depending on the color

### DETAILED DESCRIPTION

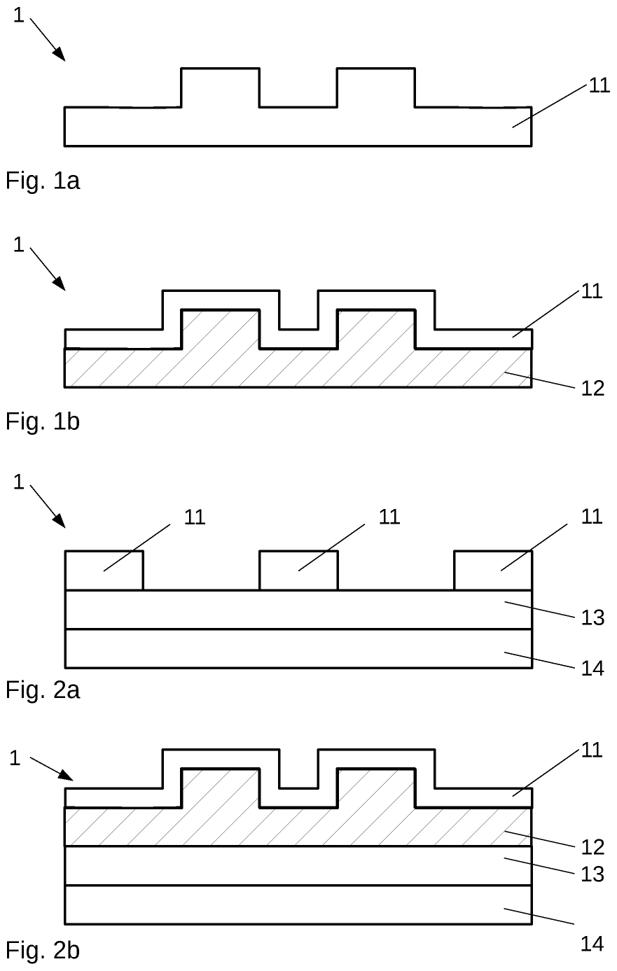

FIG. 1a shows a schematic representation of a security element 1, wherein the security element 1 has a thermochromic element 11 and wherein the thermochromic element 11 has haptic properties. By haptic properties is meant here the three-dimensional structures with elevations and depressions of the thermochromic element 11. These can preferably be sensed by humans when touched. These three-dimensional structures preferably have a height and/or depth in the range of from 0.1 μm to 70 μm, preferably from 0.5 μm to 50 μm, particularly preferably from 0.5 μm to 30 μm. These three-dimensional structures can be generated for example by different layer thicknesses, in particular during printing. However, it is additionally or alternatively also possible for the printed thermochromic element 11, preferably in the not yet cured state, to be structured by means of a stamp or a roller, with the result that these three-dimensional structures form.

If the security element 1 is used as a transfer film, in particular as a stamping film, it can also make sense to introduce the thermochromic element 11 into the adhesion-promoter layer. If the thermochromic element 11 also has haptic properties, then the haptic properties can be brought about by the locally different application weight of the adhesion-promoter layer. In addition to or instead of a different level of application weight of the adhesion-promoter layer in the decoration, the haptic properties can result from additives or thermochromic elements 11 themselves.

FIG. 1b shows a schematic representation of a security element 1, wherein the security element 1 has a thermochromic element 11 and wherein the security element 1 has a haptic layer 12. In this embodiment variant, the haptic properties are generated by the haptic layer 12.

It is preferably provided that the at least one haptic layer 12 comprises three-dimensional structures with different height and/or depth, in particular wherein the three-dimensional structures has a height and/or depth in the range of from 0.1 μm to 70 μm, preferably from 0.5 μm to 50 μm, particularly preferably from 0.5 μm to 30 μm. These three-dimensional structures can be sensed or felt by humans through touch. Here too, the three-dimensional structures can be realized by means of different application thicknesses of the print and/or structures can be introduced into the at least one haptic layer 12 by means of a stamp and/or a roller.

In the embodiment variant shown in FIG. 1b the haptic layer 12 is arranged underneath the thermochromic element 11, wherein the at least one thermochromic element 11 adapts to the three-dimensional structures of the at least one haptic layer 12. The thermochromic element 11 is also arranged over the whole surface of the haptic layer 12 in this embodiment. However, in advantageous designs it is also possible for the thermochromic element 11 to be arranged over the haptic layer 12 at least in regions.

A further schematic layer structure of a security element 1 is shown in FIG. 2a. In particular, it is provided that the security element 1 according to FIG. 2a is designed as a security strip. The security element 1 shown in FIG. 2a comprises three thermochromic elements 11, which are partially applied to the carrier layer 13. These can be applied by partial printing, for example. Further, the security element 1 comprises a primer 14, which is arranged on the side of the carrier layer 13 opposite the thermochromic elements 11. It is preferred that the carrier layer 13 has a thickness in the range of from 1 μm to 500 μm, preferably from 3 μm to 75 μm, particularly preferably from 6 μm to 50 μm.

It can also be provided that the carrier layer 13 has at least one adhesion-promotor layer, in particular wherein the adhesion-promoter layer has a thickness in a range of from 1 nm to 5 μm, preferably from 5 nm to 3 μm. The adhesion-promoter layer increases the adhesion between two layers which would otherwise not have sufficient adhesion to each other. This can be for example the adhesion between the carrier layer 13 and the thermochromic element 11.

An alternative design of a security element 1, in particular as a security strip, is shown in FIG. 2b. The security element 1 comprises a carrier layer 13 and a haptic layer 12, which is applied to the carrier layer 13 and over the whole surface of which a thermochromic element 11 is arranged. The haptic layer 12 again has the three-dimensional structures explained from FIG. 1b, to which the thermochromic element 11 adapts. A primer 14 is arranged on the side of the carrier layer 13 opposite the thermochromic element 11. This primer 14 can as a rule represent an adhesive layer or a system of several adhesive layers.

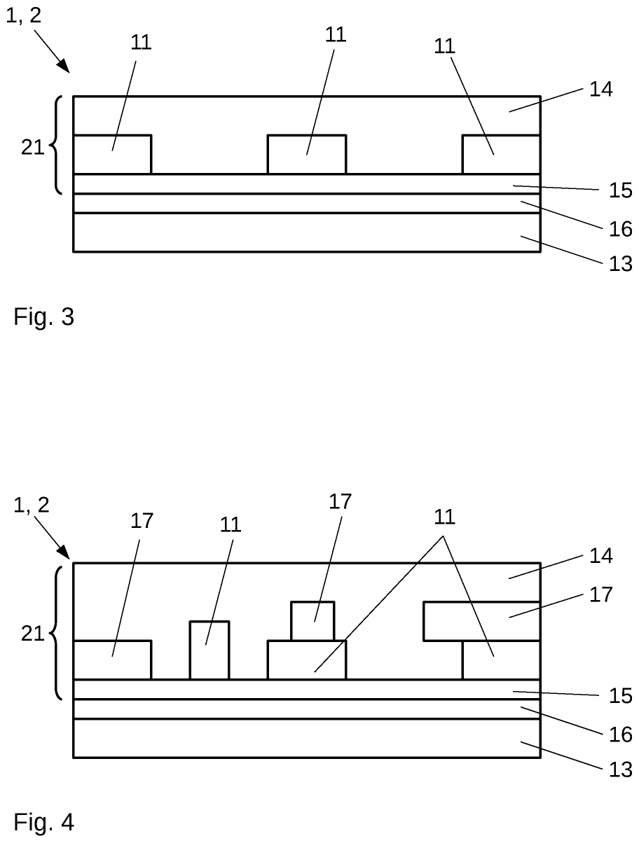

FIG. 3 shows a schematic structure of a security element 1, in particular as a transfer film 2. The security element 1 comprises a carrier layer 13 and a transfer ply 21 detachable from the carrier layer 13. The transfer ply 21 comprises three partially arranged thermochromic elements 11, a primer 14 and a protective varnish layer 15. In the design shown in FIG. 3 the security element 1 comprises a detachment layer 16, which is arranged between the carrier layer 13 and the transfer ply 21.

In the design shown in FIG. 3 the primer 14 is arranged such that it is arranged under the thermochromic elements 11 after application of the transfer ply 21 to a target substrate. On the other hand, the protective varnish layer 15 is arranged such that it is arranged over the thermochromic elements 11 after application of the transfer ply 21 to a target substrate. The protective varnish layer 15 has the function of protecting the thermochromic elements 11 from external environmental influences, such as for example mechanical, physical or chemical stress. In particular, it is provided that the protective varnish layer 15 adapts to the three-dimensional structures of the at least one thermochromic element 11. As a result, on the one hand the necessary protective effect can be ensured and on the other hand due to this design the haptic properties or the three-dimensional structures remain able to be sensed or felt by humans when touching the security element 1.

A further embodiment example of a security element 1 as a transfer film 2 is schematically represented in FIG. 4. The security element 1 comprises a carrier layer 13 and a transfer ply 21 detachable from the carrier layer 13. The transfer ply 21 comprises the primer 14, three thermochromic elements 11, a decorative ply 17, as well as a protective varnish layer 15. In addition, a detachment layer 16 is arranged between the transfer ply 21 and the carrier layer 13.

The decorative ply 17 preferably comprises at least one color layer and/or at least one replication varnish layer and/or at least one metal layer and/or at least one lens layer. Further, it is possible for the decorative ply 17 to be molded over the whole surface or patterned, for example in the form of alphanumeric characters, patterns, symbols or motifs. Further, it is expedient if the decorative ply 17 comprises further optically variable layers, for example with elements and/or substances, individually or in combination, selected from: optically variable pigments, holograms, blazed gratings, relief structures, Kinegram®, optical diffraction structures, lenses, prisms, thin film layers or liquid crystals. Thus, it is advantageous if the decorative ply 17 has at least one layer with a decorative effect.

As can be seen in FIG. 4, the decorative ply 17 is partially applied. The two partial decorative plies 17 on the right are at least partially covered by the thermochromic elements 11. If the color change point of the thermochromic element 11 is exceeded due to heat, the decorative plies 17 arranged under the thermochromic elements 11 become visible for the observer. Thus, items of information of the decorative plies 17 can be concealed at temperatures below the color change point of the thermochromic element 11, and these become visible when this color change point is exceeded. Unique security elements 1 can thereby be provided which can additionally be checked for their authenticity by the user or observer in a simple manner by touch and the associated heat transfer.

As can also be seen in FIG. 4, a decorative ply 17 can also stand alone and provide an item of information that is permanently visible for the observer. In other words, the decorative ply 17 is not covered by a thermochromic element 11. This is the case in the left-hand decorative ply 17 in FIG. 4.

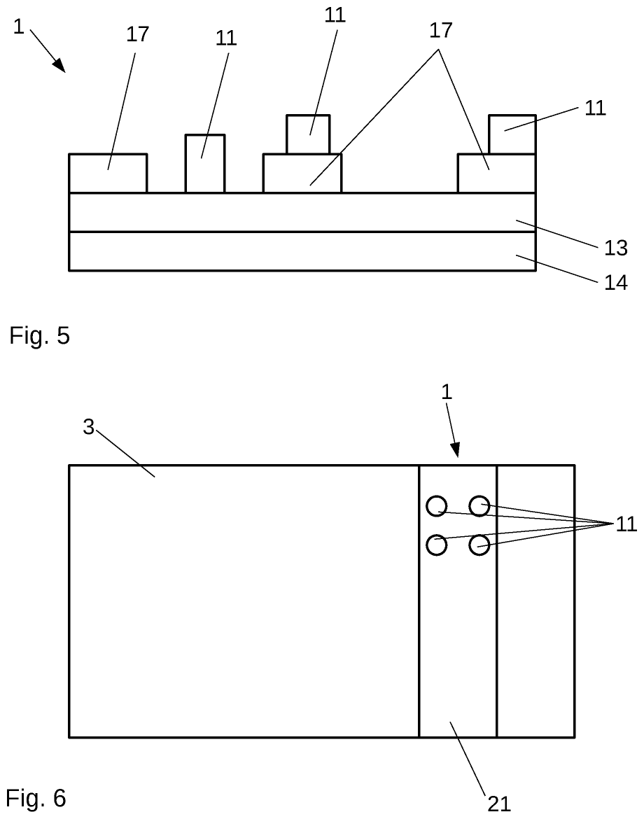

A further design of a security element 1, in particular as a security strip, is represented schematically in FIG. 5. The security element 1 comprises a carrier layer 13 and a primer 14 arranged under the carrier layer 13. Decorative plies 17, and a partial thermochromic element 11, are partially arranged on the top side of the carrier layer 13. A thermochromic element 11 is arranged in each case over the two right-hand decorative plies 17. These cover the decorative ply 17 at least partially. It is also possible for the decorative ply 17 to be completely covered by the thermochromic element 11.

Furthermore, the decorative ply 17 can also comprise a haptic layer 12, which generates three-dimensional structures, or the decorative ply 17 itself can be a haptic layer 12 and can itself generate three-dimensional structures. In combination with the thermochromic elements 11, which likewise have haptic properties, various tactile structures, which can be sensed by an observer, can thus be generated.

FIG. 6 shows a security document 3 with a security element 1 applied thereto. The security document 3 is preferably a banknote substrate made of paper or a polymer. In the design shown, the transfer ply 21 of a hot-stamping film has been applied to the security document 3 in the form of a strip on the security document 3. In particular, it is provided that the transfer ply 21 comprises an adhesive layer, in particular a hot-glue layer, which is thermally activated by a heatable embossing die or an embossing roller. A firm bond between security document 3 and transfer ply 21 or security element 1 is produced through the activation of the adhesive layer. In particular, it is also provided that the adhesive layer is cured by means of radiation, in particular UV radiation. It can also be provided that the adhesive is applied to the transfer ply 21 or to the security document 3 immediately before application of the transfer ply 21. Here too, the adhesive is then cured, in particular by means of UV radiation.

The security element 1 shown in FIG. 6 comprises four thermochromic elements 11 in the shape of circles, i.e. the thermochromic element 11 is only partially arranged in the security element 1.

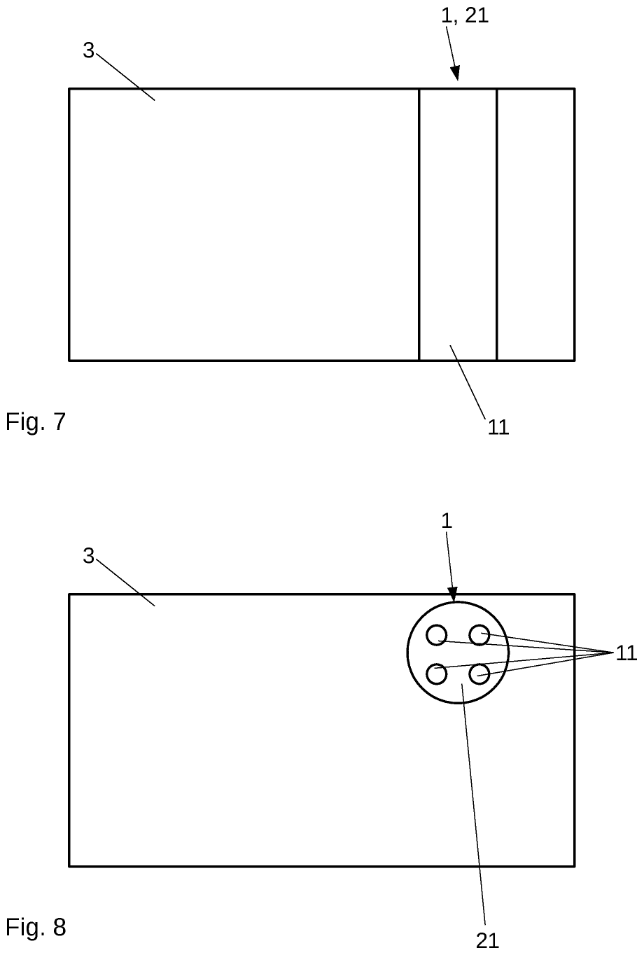

A further design variant of a security document 3 with a security element 1 applied thereto is represented in FIG. 7. The transfer ply 21 of a hot-stamping film has been applied to the security document 3 in the form of a strip. In contrast to the embodiment variant shown in

FIG. 6, in the embodiment shown in FIG. 7 the thermochromic element 11 is arranged over the whole surface. In other words, the entire security element 1 has thermochromic properties, with the result that it generates a color change in the case of heat input. However, the color change is only effected locally, at the point at which the heat is introduced, for example by being touched by a finger of an observer or user. Depending on the thermal conductivity of the thermochromic element 11, the heat can be conducted more quickly or more slowly inside the thermochromic element 11, with the result that points neighboring the heat input point can also perform a color change.

A further design of a security document 3 with a security element 1 applied thereto is represented in FIG. 8. Here, the security element 1 is designed as a patch, which has been applied to the security document 3 as a transfer ply 21 of a hot-stamping film by means of a hot embossing die. Alternatively, such a patch can also be applied as a cold-stamping film or as a laminating film. The security element 1 in the form of a patch has four partially arranged thermochromic elements 11 in the shape of circles. In addition, these thermochromic elements 11 have elevations and depressions as three-dimensional structures, which can be sensed or felt by humans when touched.

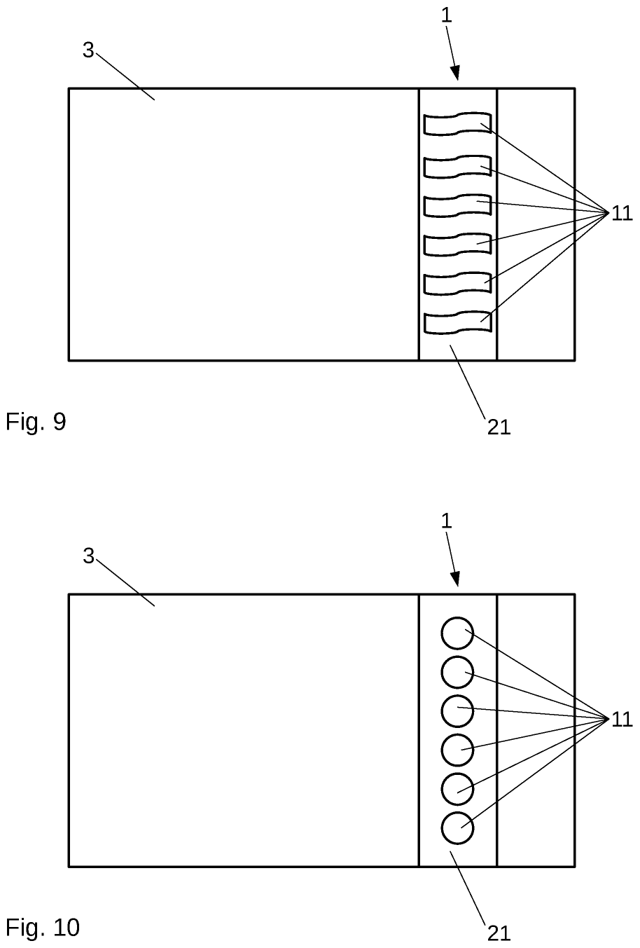

A further design variant of a security document 3 with a security element 1 applied thereto is represented in FIG. 9. The security element 1 is a strip which has been transferred onto or into the security document 3 as a transfer ply 21 of a hot-stamping film or a cold-stamping film or as a thread embedded in the document substrate or as a laminating film. The security element 1 comprises six thermochromic elements 11, which are designed in the shape of waves. The waves are raised compared with the rest of the security element 1, with the result that they generate a haptic surface which can be sensed by humans when touched. It is advantageous that the waves being touched is at the same time accompanied by a heat input, which ensures that the waves change their color. This is thus a double authentication of the security document 3 for its authenticity, wherein only one checking step, namely touching the waves, needs to be carried out. The observer takes the three-dimensional structures of the waves when touching them was and can additionally observe a color change of the waves.

FIG. 10 shows a further embodiment variant of a security document 3 with a security element 1 applied thereto. The structure is similar to the embodiment variant shown in FIG. 9, but with the difference that the thermochromic elements 11 with haptic properties are implemented as dots.

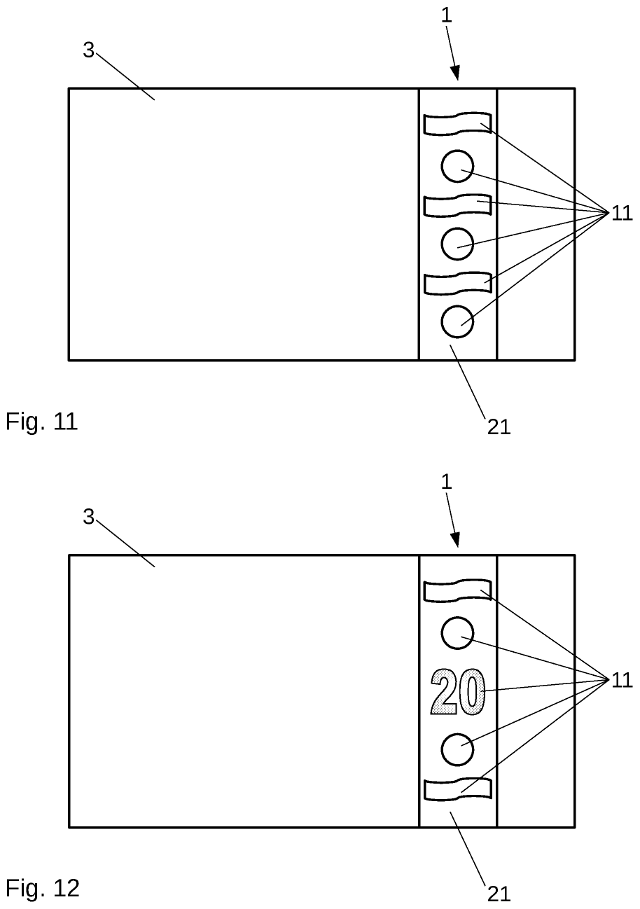

A further design variant of a security document 3 with a security element 1 applied thereto as a strip is represented in FIG. 11. The security element 1 comprises six thermochromic elements 11, which are designed in an alternating manner as a wave and as a dot. A diverse haptic impression can hereby be generated, as the observer has to perform a continuous movement along the strip when touching it, in order to be able to perceive all of the haptic impressions and to check the security element 1 for its authenticity. Through the continuous movement during the touching, a heat input is also effected over the entire length of the strip, with the result that the thermochromic elements 11 generate a color change because of the heat input by body heat.

FIG. 12 shows a further design of a security document 3 with a security element 1 applied thereto as a strip. The security element 1 has five thermochromic elements 11, wherein the outer two are designed as waves. The middle thermochromic element 11 is designed as a “20”, which is combined with freeform lenses. The freeform lenses are preferably arranged above the thermochromic element 11 and, because of the optical lens structure, suggest a surface relief, which is always visible for the observer. Due to the action of heat on the thermochromic element 11, the latter changes its color for example from blue to colorless. The optical lens effect persists and remains visible for the observer before and after the action of heat.

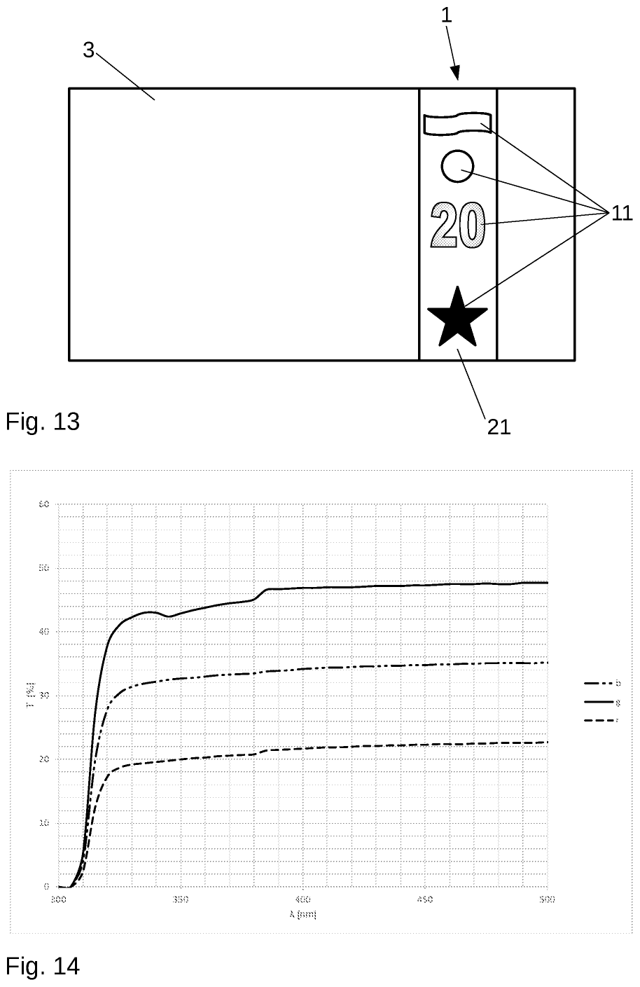

FIG. 13 shows a further schematic representation of a security document 3 with a security element 1 applied thereto. The security element 1 comprises four thermochromic elements 11. The first thermochromic element 11 is designed as a wave, the second thermochromic element 11 is designed as a dot, the third thermochromic element 11 is designed as a “20” with an optical lens structure and the fourth thermochromic element 11 is designed as a star. In the case of the action of heat and the resultant temperature change, a color change of the “20” from, for example, blue to colorless is brought about. In the case of the star, the thermochromic element 11 is arranged over a golden color layer, wherein the golden color layer is likewise formed as a star. The thermochromic element 11 is arranged register-accurate relative to the color layer. To the observer, the thermochromic element 11 appears black at a temperature below the color change point and colorless at a temperature above the color change point. Thus, if a heat input is effected on the star, the thermochromic element 11 thus changes its color from black to colorless in the region of the star. The golden color layer lying underneath it in the shape of a star becomes visible for the observer. With this arrangement of thermochromic element 11 above a color layer, all conceivable color combinations and color changes are possible, whereby a diverse optical impression is generated, which at the same time makes it possible to check the security element 1 for authenticity.

Results of a measurement of transmittances of different thermochromic elements 11 depending on the layer thickness and the respective color of the thermochromic element 11 are represented in FIGS. 14 to 17. For this purpose, different thermochromic elements 11 with different color impressions yellow g, blue b, pink r and black s have been used. In each case these have a color change point in a temperature range of from 25° C. to 30° C. The at least one thermochromic element 11 preferably has at least one color varnish, wherein the color varnish comprises at least one dye and at least one binder. The dye can be a combination of conventional and thermochromic colorants. The conventional and thermochromic colorants are preferably solids.

For the transmittance measurement, the thermochromic elements 11 or thermochromic layers were applied to a PET carrier and measured together with it. However, in order to determine the transmittance of the thermochromic elements 11 or of the thermochromic layers, the transmittance of the PET carrier without thermochromic layer was measured. During this measurement, it emerged that the PET carrier has a transmittance of approximately 90% in the wavelength range of from 300 nm to 800 nm, in particular from 300 nm to 500 nm. For the assessment of the measurement results, the effect of the PET carrier layer 13 can therefore be regarded as negligible.

The transmittance measurements of the thermochromic layers were carried out at room temperature, approx. 21° C., and thus below the color change point of the thermochromic elements 11.

To measure the transmittance, a spectrophotometer manufactured by Hitachi, with the model name U-2000, was used.

FIG. 14 shows the results of the transmittance measurements at a temperature of 21° C. for a yellow thermochromic layer g, a blue thermochromic layer b and a pink thermochromic layer r with a thickness in the range of from 1.0 μm to 1.8 μm in the wavelength range of from 300 nm to 500 nm. In particular, it is provided that the at least one thermochromic element 11 has a thickness in the range of from 1.0 μm to 1.8 μm and, in the wavelength range of from 300 nm to 800 nm, in particular from 300 nm to 500 nm, at a temperature in the range of from 20° C. to 25° C., has a transmittance of at most 70%, preferably at most 65%, particularly preferably at most 60%.

It is preferably also possible for the at least one thermochromic element 11 to have a thickness in the range of from 1.0 μm to 1.8 μm and to have a hue on the RAL chart selected from RAL 1000 to RAL 1037, in particular a yellow hue from the RAL Classic collection, and, in the wavelength range of from 300 nm to 800 nm, in particular from 300 nm to 500 nm, at a temperature in the range of from 20° C. to 25° C., to have a transmittance of at most 70%, preferably at most 65%, particularly preferably at most 60%.

It is preferably also possible for the at least one thermochromic element 11 to have a thickness in the range of from 1.0 μm to 1.8 μm and to have a hue on the RAL chart selected from RAL 5000 to RAL 5026, in particular a blue hue from the RAL Classic collection, and, in the wavelength range of from 300 nm to 800 nm, in particular from 300 nm to 500 nm, at a temperature in the range of from 20° C. to 25° C., to have a transmittance of at most 70%, preferably at most 65%, particularly preferably at most 60%.

It is preferably also possible for the at least one thermochromic element 11 to have a thickness in the range of from 1.0 μm to 1.8 μm and to have a hue on the RAL chart selected from RAL 4001 to RAL 4012, in particular a purple hue from the RAL Classic collection, and, in the wavelength range of from 300 nm to 800 nm, in particular from 300 nm to 500 nm, at a temperature in the range of from 20° C. to 25° C., to have a transmittance of at most 70%, preferably at most 65%, particularly preferably at most 60%.

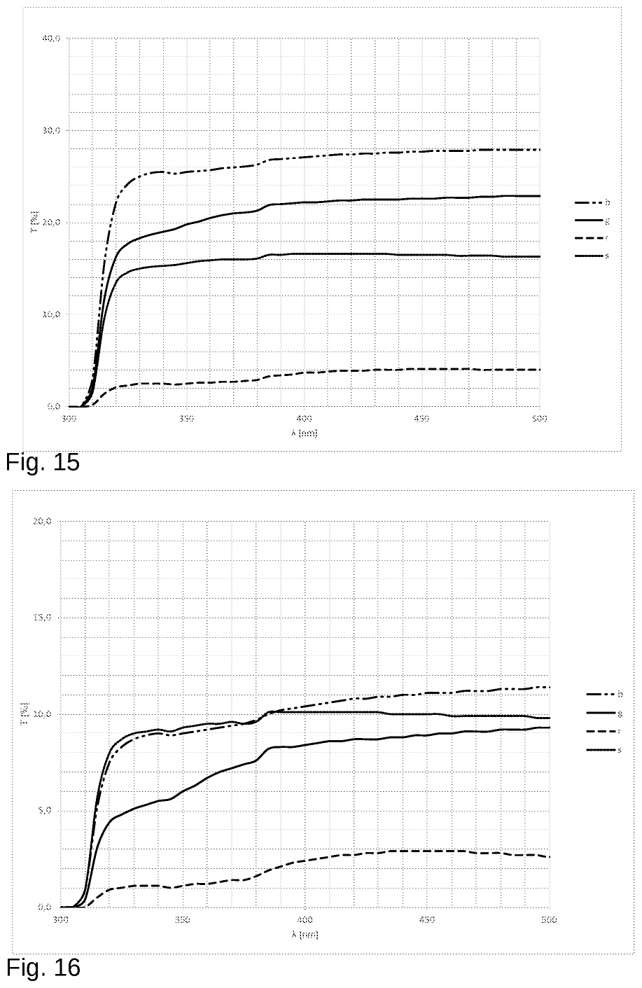

FIG. 15 shows the results of the transmittance measurements at a temperature of 21° C. for a yellow thermochromic layer g, a blue thermochromic layer b, a black thermochromic layer s and a pink thermochromic layer r with a thickness in the range of from 1.6 μm to 2.4 μm in the wavelength range of from 300 nm to 500 nm. In particular, it is provided that the at least one thermochromic element 11 has a thickness in the range of from 1.6 μm to 2.4 μm and, in the wavelength range of from 300 nm to 800 nm, in particular from 300 nm to 500 nm, at a temperature in the range of from 20° C. to 25° C., has a transmittance of at most 50%, preferably at most 45%, particularly preferably at most 40%.

It is preferably also possible for the at least one thermochromic element 11 to have a thickness in the range of from 1.6 μm to 2.4 μm and to have a hue on the RAL chart selected from RAL 1000 to RAL 1037, in particular a yellow hue from the RAL Classic collection, and, in the wavelength range of from 300 nm to 800 nm, in particular from 300 nm to 500 nm, at a temperature in the range of from 20° C. to 25° C., to have a transmittance of at most 50%, preferably at most 45%, particularly preferably at most 40%.

It is preferably also possible for the at least one thermochromic element 11 to have a thickness in the range of from 1.6 μm to 2.4 μm and to have a hue on the RAL chart selected from RAL 5000 to RAL 5026, in particular a blue hue from the RAL Classic collection, and, in the wavelength range of from 300 nm to 800 nm, in particular from 300 nm to 500 nm, at a temperature in the range of from 20° C. to 25° C., to have a transmittance of at most 50%, preferably at most 45%, particularly preferably at most 40%.

It is preferably also possible for the at least one thermochromic element 11 to have a thickness in the range of from 1.6 μm to 2.4 μm and to have a hue on the RAL chart selected from RAL 4001 to RAL 4012, in particular a purple hue from the RAL Classic collection, and, in the wavelength range of from 300 nm to 800 nm, in particular from 300 nm to 500 nm, at a temperature in the range of from 20° C. to 25° C., to have a transmittance of at most 50%, preferably at most 45%, particularly preferably at most 40%.

It is preferably also possible for the at least one thermochromic element 11 to have a thickness in the range of from 1.6 μm to 2.4 μm and to have a hue on the RAL chart selected from RAL 9004, RAL 9005, RAL 9011, RAL 9017, in particular a black hue from the RAL Classic collection, and, in the wavelength range of from 300 nm to 800 nm, in particular from 300 nm to 500 nm, at a temperature in the range of from 20° C. to 25° C., to have a transmittance of at most 50%, preferably at most 45%, particularly preferably at most 40%.

FIG. 16 shows the results of the transmittance measurements at a temperature of 21° C. for a yellow thermochromic layer g, a blue thermochromic layer b, a black thermochromic layer s and a pink thermochromic layer r with a thickness in the range of from 2.7 μm to 3.3 μm in the wavelength range of from 300 nm to 500 nm. In particular, it is provided that the at least one thermochromic element 11 has a thickness in the range of from 2.7 μm to 3.3 μm and, in the wavelength range of from 300 nm to 800 nm, in particular from 300 nm to 500 nm, at a temperature in the range of from 20° C. to 25° C., has a transmittance of at most 40%, preferably at most 35%, particularly preferably at most 30%.

It is preferably also possible for the at least one thermochromic element 11 to have a thickness in the range of from 2.7 μm to 3.3 μm and to have a hue on the RAL chart selected from RAL 1000 to RAL 1037, in particular a yellow hue from the RAL Classic collection, and, in the wavelength range of from 300 nm to 800 nm, in particular from 300 nm to 500 nm, at a temperature in the range of from 20° C. to 25° C., to have a transmittance of at most 40%, preferably at most 35%, particularly preferably at most 30%.

It is preferably also possible for the at least one thermochromic element 11 to have a thickness in the range of from 2.7 μm to 3.3 μm and to have a hue on the RAL chart selected from RAL 5000 to RAL 5026, in particular a blue hue from the RAL Classic collection, and, in the wavelength range of from 300 nm to 800 nm, in particular from 300 nm to 500 nm, at a temperature in the range of from 20° C. to 25° C., to have a transmittance of at most 40%, preferably at most 35%, particularly preferably at most 30%.

It is preferably also possible for the at least one thermochromic element 11 to have a thickness in the range of from 2.7 μm to 3.3 μm and to have a hue on the RAL chart selected from RAL 4001 to RAL 4012, in particular a purple hue from the RAL Classic collection, and, in the wavelength range of from 300 nm to 800 nm, in particular from 300 nm to 500 nm, at a temperature in the range of from 20° C. to 25° C., to have a transmittance of at most 40%, preferably at most 35%, particularly preferably at most 30%.

It is preferably also possible for the at least one thermochromic element 11 to have a thickness in the range of from 2.7 μm to 3.3 μm and to have a hue on the RAL chart selected from RAL 9004, RAL 9005, RAL 9011, RAL 9017, in particular a black hue from the RAL Classic collection, and, in the wavelength range of from 300 nm to 800 nm, in particular from 300 nm to 500 nm, at a temperature in the range of from 20° C. to 25° C., to have a transmittance of at most 40%, preferably at most 35%, particularly preferably at most 30%.

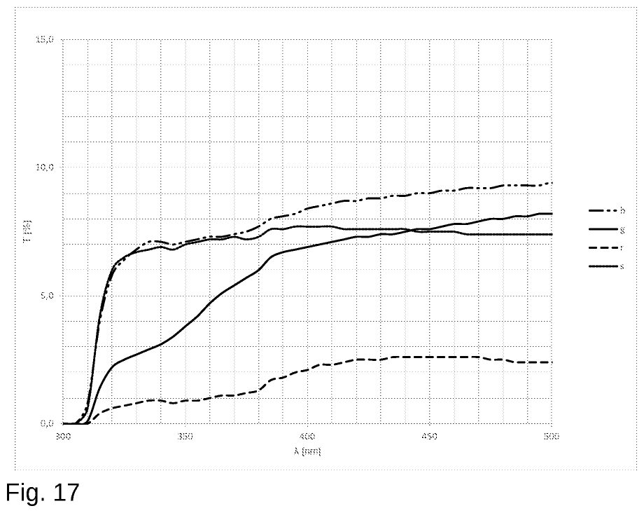

FIG. 17 shows the results of the transmittance measurements at a temperature of 21° C. for a yellow thermochromic layer g, a blue thermochromic layer b, a black thermochromic layer s and a pink thermochromic layer r with a thickness in the range of from 3.6 μm to 4.4 μm in the wavelength range of from 300 nm to 500 nm. In particular, it is provided that the at least one thermochromic element 11 has a thickness in the range of from 3.6 μm to 4.4 μm and, in the wavelength range of from 300 nm to 800 nm, in particular from 300 nm to 500 nm, at a temperature in the range of from 20° C. to 25° C., has a transmittance of at most 30%, preferably at most 25%, particularly preferably at most 20%.

It is preferably also possible for the at least one thermochromic element 11 to have a thickness in the range of from 3.6 μm to 4.4 μm and to have a hue on the RAL chart selected from RAL 1000 to RAL 1037, in particular a yellow hue from the RAL Classic collection, and, in the wavelength range of from 300 nm to 800 nm, in particular from 300 nm to 500 nm, at a temperature in the range of from 20° C. to 25° C., to have a transmittance of at most 30%, preferably at most 25%, particularly preferably at most 20%.

It is preferably also possible for the at least one thermochromic element 11 to have a thickness in the range of from 3.6 μm to 4.4 μm and to have a hue on the RAL chart selected from RAL 5000 to RAL 5026, in particular a blue hue from the RAL Classic collection, and, in the wavelength range of from 300 nm to 800 nm, in particular from 300 nm to 500 nm, at a temperature in the range of from 20° C. to 25° C., to have a transmittance of at most 30%, preferably at most 25%, particularly preferably at most 20%.

It is preferably also possible for the at least one thermochromic element 11 to have a thickness in the range of from 3.6 μm to 4.4 μm and to have a hue on the RAL chart selected from RAL 4001 to RAL 4012, in particular a purple hue from the RAL Classic collection, and, in the wavelength range of from 300 nm to 800 nm, in particular from 300 nm to 500 nm, at a temperature in the range of from 20° C. to 25° C., to have a transmittance of at most 30%, preferably at most 25%, particularly preferably at most 20%.

It is preferably also possible for the at least one thermochromic element 11 to have a thickness in the range of from 3.6 μm to 4.4 μm and to have a hue on the RAL chart selected from RAL 9004, RAL 9005, RAL 9011, RAL 9017, in particular a black hue from the RAL Classic collection, and, in the wavelength range of from 300 nm to 800 nm, in particular from 300 nm to 500 nm, at a temperature in the range of from 20° C. to 25° C., to have a transmittance of at most 30%, preferably at most 25%, particularly preferably at most 20%.

### LIST OF REFERENCE NUMBERS

1 security element
11 thermochromic element
12 haptic layer
13 carrier layer
14 primer
15 protective varnish layer
16 detachment layer
17 decorative ply
2 transfer film
21 transfer ply
3 security document
b blue thermochromic layer
g yellow thermochromic layer
r pink thermochromic layer
s black thermochromic layer

What is claimed is:

1. A security element for protecting security documents,
wherein the security element has at least one thermochromic element, and wherein
i) the at least one thermochromic element has haptic properties; and/or
ii) the security element has at least one haptic layer.

2. The security element according to claim 1, wherein the security element comprises a carrier layer and/or at least one primer and/or at least one protective varnish layer.

3. The security element according to claim 2, wherein the at least one primer is arranged on the side of the carrier layer opposite the at least one thermochromic element.

4. The security element according to claim 2, wherein the at least one protective varnish layer is arranged above the at least one thermochromic element.

5. The security element according to claim 2, wherein the security element has a transfer ply detachable from the carrier layer.

6. The security element according to claim 5, wherein the at least one primer is arranged such that it is arranged under the at least one thermochromic element after application of the transfer ply to a target substrate.

7. The security element according to claim 5, wherein the at least one protective varnish layer is arranged such that it is arranged over the at least one thermochromic element after application of the transfer ply to a target substrate.

8. The security element according to claim 2, wherein the security element comprises a detachment layer.

9. The security element according to claim 5, wherein the transfer ply or the security element has a decorative ply.

10. The security element according to claim 1, wherein the at least one thermochromic element is arranged over the whole surface or at least in regions.

11. The security element according to claim 9, wherein at least one metal layer is arranged under the at least one thermochromic element.

12. The security element according to one of claim 9, wherein the at least one thermochromic element is designed as an etch resist for the structuring of the at least one metal layer and/or as an exposure mask for the structuring of an etch resist.

13. The security element according to claim 1, wherein the at least one thermochromic element has a color change point in a temperature range of from −20° C. to 120° C., with the result that when this color change point is exceeded the appearance of the at least one thermochromic element changes from a first color to a second color, and/or when this color change point is fallen below the appearance of the at least one thermochromic element changes from the second color to a first color.

14. The security element according to claim 1, wherein the at least one thermochromic element comprises at least one thermochromic colorant, and/or wherein the at least one thermochromic element comprises a first varnish layer with at least one thermochromic colorant and a second varnish layer with at least one colorant.

15. The security element according to claim 1, wherein the at least one thermochromic element comprises a first varnish layer with at least one first thermochromic colorant and a second varnish layer with at least one second thermochromic colorant.

16. The security element according to claim 14, wherein the first varnish layer and the second varnish layer have a color difference ΔE in the range of from 50 to 270.

17. The security element according to claim 1, wherein the at least one thermochromic element has a color change duration of less than 5 seconds.

18. The security element according to claim 13, wherein the at least one thermochromic element is oriented towards a visible face, which is visible for the observer, and wherein layers arranged underneath the at least one thermochromic element provide at least one item of information which is at least partially or completely concealed from an observer in the case of a temperature range below the color change point from the first color of the at least one thermochromic element and is visible for the observer in the case of a temperature range above the color change point because of the second color of the thermochromic element.

19. The security element according to claim 1, wherein the proportion of a thermochromic component in the at least one thermochromic element lies in the range of from 20% to 80%.

20. The security element according to claim 1, wherein the at least one thermochromic element comprises solids, and solvents.

21. The security element according to claim 1, wherein the at least one thermochromic element has a solids content in the range of from 20 wt.-% to 80 wt.-%.

22. The security element according to claim 1, wherein the at least one thermochromic element has a thermal conductivity in the range of from 0.001 W/m*K to 8000 W/m*K.

23. The security element according to claim 1, wherein the at least one haptic layer comprises three-dimensional structures with different height and/or depth.

24. The security element according to claim 23, wherein the at least one haptic layer is arranged underneath the at least one thermochromic element.

25. The security element according to claim 23, wherein the three-dimensional structures of the at least one haptic layer are designed as dots, waves, lines and/or combinations thereof and/or as a decorative element.

26. The security element according to claim 1, wherein the at least one haptic layer and/or the at least one thermochromic element comprises replicated structures, and/or wherein the at least one haptic layer and/or the at least one thermochromic element has additives.

27. The security element according to claim 1, wherein the at least one thermochromic element comprises three-dimensional structures with different height and/or depth for generating the haptic properties.

28. The security element according to claim 27, wherein the three-dimensional of the structures of the at least one thermochromic element form through variation of the print thickness and/or through the addition of additives.

29. The security element according to claim 27, wherein the three-dimensional structures of the at least one thermochromic element are designed as dots, waves, lines and/or combinations thereof and/or as a decorative element.

30. A method for producing a security element, wherein the following steps are carried out:
providing at least one thermochromic element and/or applying at least one thermochromic element to a target substrate or a carrier layer,
wherein
i) the at least one thermochromic element has haptic properties; and/or
ii) at least one haptic layer is applied.

31. The method according to claim 30, wherein the method further comprises the following step:
providing a carrier layer.

32. The method according to claim 30, wherein the method further comprises the following step:
applying at least one primer.

33. The method according to claim 30, wherein the method further comprises the following step:
applying a transfer ply detachable from the carrier layer.

34. The method according to claim 31, wherein the method further comprises the following step:
applying a detachment layer to the carrier layer by means of printing processes.

35. The method according to claim 33, wherein the transfer ply has a decorative ply.

36. The method according to claim 35, wherein the at least one thermochromic element is applied over the at least one metal layer.

37. The method according to claim 30, wherein structures replicated into at least one haptic layer and/or the at least one thermochromic element are introduced and/or wherein additives are introduced into the at least one haptic layer and/or the at least one thermochromic element.
